(19) United States
(12) Patent Application Publication
(10) Pub. No.: US 2016/0283793 A1
(43) Pub. Date: Sep. 29, 2016

(54) PRESENTING VARYING PROFILE DETAIL LEVELS FOR INDIVIDUALS RECOGNIZED IN VIDEO STREAMS

(71) Applicants: ALEXANDER LECKEY, Kilcock (IE); MARIA MANNION, Dublin (IE); DAVID MCKITTERICK, Dublin (IE)

(72) Inventors: ALEXANDER LECKEY, Kilcock (IE); MARIA MANNION, Dublin (IE); DAVID MCKITTERICK, Dublin (IE)

(21) Appl. No.: 14/125,184

(22) PCT Filed: Sep. 9, 2013
(86) PCT No.: PCT/US2013/058705

§ 371 Date: Dec. 10, 2013

(51) Int. Cl. G06K 9/00; G06F 3/0485; G06F 3/0481; G06T 11/60

(52) U.S. Cl. CPC G06K 9/00671; G06K 9/00295; G06K 9/00677; G06T 11/60; G06F 3/04855; G06F 3/04817; G06T 2200/24

(57) ABSTRACT

Systems and methods may provide for generating a camera view based on image data and overlaying an area adjacent to a face of a first individual in the camera view with a first graphical indication of a basis for a first priority level associated with the first individual. Additionally, a sidebar may be displayed adjacent to the camera view, wherein the sidebar includes a first textual profile of the first individual. In one example, the first graphical indication includes one or more icons.

### TECHNICAL FIELD

Embodiments generally relate to facial recognition frameworks. More particularly, embodiments relate to presenting varying levels of profile detail for individuals recognized in video streams.

### BACKGROUND

Conventional facial recognition frameworks may match faces detected in video streams against known facial data in order to facilitate the retrieval of information regarding individuals in the video stream. Presenting the retrieved information, however, to a user of the facial recognition framework (e.g., viewer of the video feed) may be challenging, particularly when the video stream contains large crowds of recognized individuals. For example, presenting too much information may lead to information overload and/or confusion on the part of the user, whereas presenting too little information may prevent the user from obtaining the desired level of detail. These challenges may be intensified in real-time and/or time-sensitive settings.

### BRIEF DESCRIPTION OF THE DRAWINGS

The various advantages of the embodiments will become apparent to one skilled in the art by reading the following specification and appended claims, and by referencing the following drawings, in which:

FIG. 1A is an illustration of an example of a camera view and sidebar according to an embodiment;

FIG. 1B is an illustration of an example of a split overlay according to an embodiment;

FIG. 2 is a flowchart of an example of a method of presenting profile information according to an embodiment;

FIG. 3 is a flowchart of an example of a method of using display thresholds and recommendation rankings to present profile information according to an embodiment;

FIG. 4 is a block diagram of an example of a logic architecture according to an embodiment;

FIG. 5 is a block diagram of an example of a processor according to an embodiment; and

FIG. 6 is a block diagram of an example of a system according to an embodiment.

### DESCRIPTION OF EMBODIMENTS

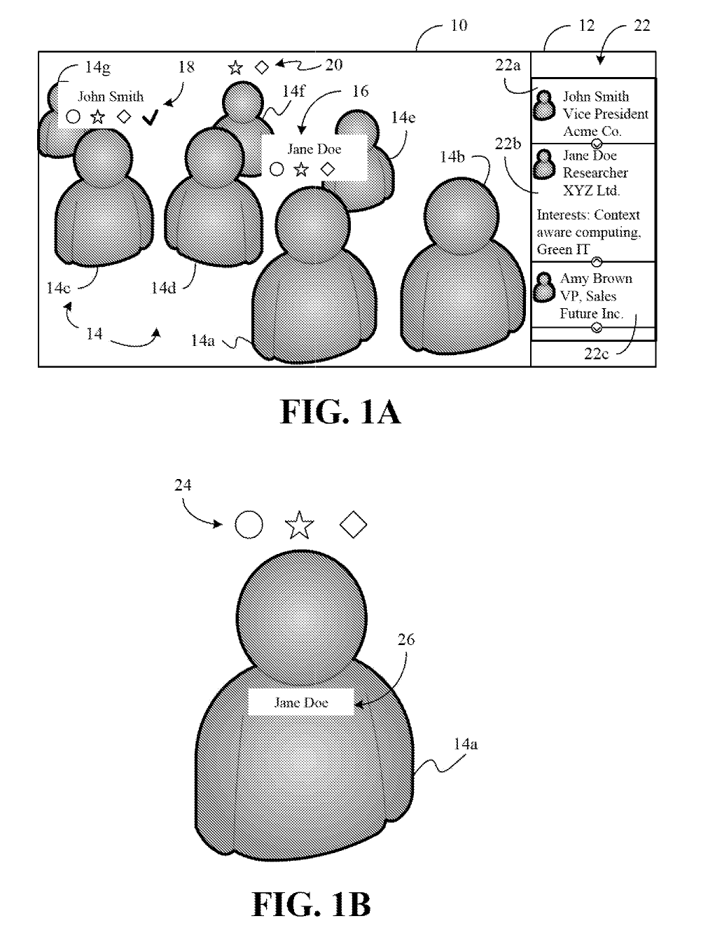

Turning now to FIGS. 1A and 1B, a user interface is shown in which a camera view 10 is generated based on a video feed and/or image data containing the likenesses of one or more individuals 14 (14a-14g). The image data may be received from a fixed camera (e.g., security and/or surveillance camera), a mobile camera (e.g., smart phone camera, tablet camera, head mounted camera, etc.), and so forth, or any combination thereof. Moreover, the scene reflected in the image data may contain a relatively large number of individuals 14 in a setting such as, for example, a party, conference/seminar, meeting, political rally, sporting event, and so forth. In the illustrated example, individuals whose faces are recognized by a facial recognition system may be automatically prioritized/recommended based on one or more factors related to a viewer of the user interface (e.g., person/user viewing the user interface). The prioritization factors may include, but are not limited to, a shared interest, social networking connection, shared organization and/or real-time physical proximity between the individual in the camera view and the user. In addition, the prioritization factors may be established via one or more configurable user, group or organizational preferences/settings.

Graphical indications may generally be overlaid on the camera view 10 in order to quickly convey the basis for the prioritizations to the user. For example, the area adjacent to the face of a first individual 14a may be overlaid with a graphical indication 16, wherein the graphical indication 16 may include one or more icons that correspond to the relevant prioritization factors. Thus, a circle might indicate a social networking (e.g., FACEBOOK®, LINKEDIN®) connection between the individual 14a and the user, a star may indicate a shared interest between the individual 14a and the user, a diamond may indicate a shared organization between the individual 14a and the user, and so forth. The icons may alternatively include logos (e.g., FACEBOOK® logo, LINKEDIN® logo), avatars and other easily recognizable images (e.g., thumbs up) so that the user may instantaneously understand the relevance of the individual 14a to the user in question. In the illustrated example, a name (e.g., “Jane Doe”) of the individual 14a is also overlaid on the area adjacent to the face of the individual 14a.

The graphical indications may be used for multiple faces recognized in the image data. For example, the area adjacent to a second individual 14c may be overlaid with another graphical indication 18 that includes a circle, star, diamond and checkmark (e.g., signifying some other basis for the assigned priority level), as well as a name (e.g., “John Smith”) of the second individual 14c. Similarly, a graphical indication 20 may be overlaid on the area adjacent to the face of a third individual 14f, wherein the illustrated graphical indication 20 includes only a star and a diamond. Thus, the user may quickly determine from the graphical indications 16, 18, 20 that the second individual 14c has been assigned the highest priority level, the first individual 14a has been assigned the next highest priority level and the third individual 14f has been assigned the lowest priority level, among the recognized individuals. The remaining individuals 14b, 14d, 14e, 14g, who are not recognized, do not receive graphical indication overlays, in the illustrated example.

The relative size of the graphical indications 16, 18, 20 may also vary as a function of one or more display constraints (e.g., thresholds), the sizes of the recognized faces (e.g., indicating depth in the image/video), as well as the respective priority levels. For example, the size of the boxes around the graphical indications 16, 18 may be set to be relatively large due to the importance of the corresponding individuals 14a, 14c, respectively, and availability of display area on the screen. The size of the box around the graphical indication 20, on the other hand, may be set to be relatively small due to the lower priority level assigned to the third individual 14f. Such an approach may enable the user to locate the most important people in a crowd, even if they are farther away than other recognized individuals in the crowd. Reducing the size of the box below a certain level may also lead to removing the individual's name from the box, as in the case of the illustrated graphical indication 20.

The size of the graphical indications 16, 18, 20 may also be a function of the proximity of the individual to the camera (and therefore proximity to the user if the user is holding/wearing the camera in a real-time setting). Setting the size (as well as the associated priority levels) of the graphical indications 16, 18, 20 based on real-time physical proximity to the user may enable the user to obtain additional information such as, for example, names of individuals as the user approaches those individuals. FIG. 1B demonstrates that a graphical indication 24 may be displayed separately from a name 26 of the individual 14a in the area adjacent to the face of the individual. Such a split overlay approach may enable the name 26 to have the look and feel of a nametag.

The illustrated user interface also includes a scrollable sidebar 12 displayed adjacent to the camera view 10 wherein the sidebar 12 may include textual profiles 22 (22a-22c) of the recognized individuals 14a, 14c, 14f. The textual profiles 22 may include additional information about the recognized individuals 14a, 14e, 14f such as for example, title, company, etc. Moreover, the textual profiles 22 may be expandable to show even more detailed information such as, for example, interests, home town, etc. In the illustrated example, the relative position of the textual profiles 22 is determined based on the respective priority levels of the recognized individuals 14a, 14c, 14f. Thus, the top textual profile 22a may correspond to the second (e.g., highest priority) individual 14c, the middle textual profile 22b may correspond to the first (e.g., middle priority) individual 14a and the bottom textual profile 22c might correspond to the third (e.g., lowest priority) individual 14f, in the example shown.

Thus, the illustrated user interface may be helpful to users in various different settings. For example, the user interface may enable conference attendees, party goers, politicians, Alzheimer's patients, law enforcement officials, etc., to obtain useful information about the people they encounter on a real-time basis. Other applications may also benefit from the techniques described herein.

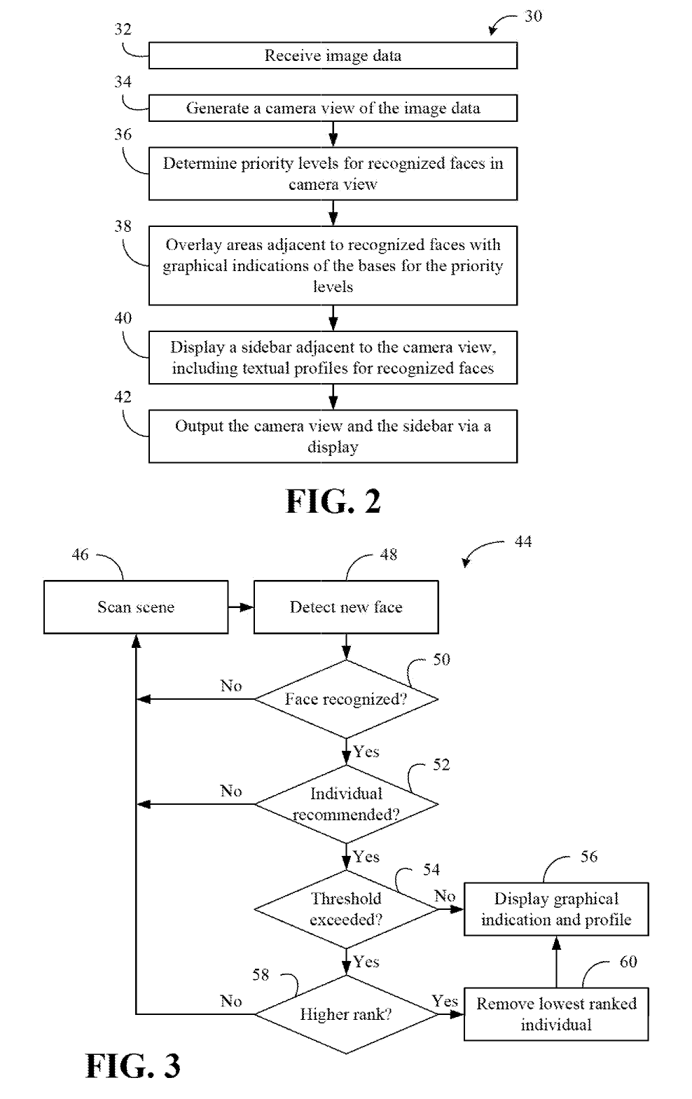

Turning now to FIG. 2, a method 30 of presenting profile information is shown. The method 30 may be implemented as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 30 may be written in any combination of one or more programming languages, including an object oriented programming language such as Java, Smalltalk, C++ or the like and conventional procedural programming languages, such as the “C” programming language or similar programming languages.

Illustrated processing block 32 provides for receiving image data such as a video feed and/or one or more still images. As already noted, the image data may be received from a fixed and/or mobile camera and the scene(s) reflected in the image data may contain a plurality of individuals in one or more settings such as, for example, a party, conference/seminar, political rally, meeting, sporting event, and so forth. A camera view of the image data may be generated at block 34, wherein illustrated block 36 determines priority levels for recognized faces in the camera view. Block 36 may therefore take into consideration a wide variety of factors such as, for example, shared interests, social networking connections, shared organizations, real-time physical proximity, and so forth.

For example, a point system might be used to rank and/or score the importance (e.g., prioritize) of the recognized individuals/faces in the image data. Thus, one point might be awarded for a particular type of social networking connection (e.g., FACEBOOK®), three points may be awarded for another type of social networking connection (e.g., LINKEDIN®), and five points might be awarded for a shared organization (e.g., same employer, school, etc.). Summing the points assigned to a given individual may provide a basis for a final priority level and/or recommendation for the individual to the user. The specific values provided herein are to facilitate discussion only. The points may also be weighted to bias results towards or away from one or more factors.

Block 38 may overlay areas adjacent to recognized faces in the camera view with graphical indications of the bases for the assigned priority levels. In one example, the graphical indications include icons that correspond to the factors leading to a particular priority level. Thus, for example, one or more shared interest icons, social networking connection icons, shared organization icons and/or physical proximity icons may be overlaid on the camera view adjacent to the face of each recognized individual as appropriate. In addition, the relative size of the graphical indications may be determined based on one or more display constraints, the priority levels of the corresponding individuals, and so forth. Block 38 may also provide for overlaying the areas adjacent to the recognized faces with the names of the corresponding individuals. The names may be obtained from an appropriate database, social networking site, cloud server or other source of individual information.

A sidebar may be displayed adjacent to the camera view at block 40, wherein the sidebar may include textual profiles for the recognized individuals. As already noted, the relative position of the textual profiles may he determined based on the priority levels of the corresponding individuals. Illustrated block 42 provides for outputting the camera view and the sidebar view via a display. The display may be part of the same or a different device that captured the image data. For example, in the case of a mobile device such as a wireless smart phone, tablet, convertible tablet, head mounted camera and display (e.g., GOOGLE® GLASS), etc., the image data might be captured using a rear facing camera of the mobile device, while the annotated camera view and sidebar may be shown on a front facing display of the mobile device.

Alternatively, in the case of separate devices, the image data may be captured using a camera of a first device such as, for example, a surveillance/security system, wearable camera, etc., and the annotated camera view and sidebar may be shown on the display of a second device such as, for example, a smart watch, wireless smart phone, etc. The head mounted camera and display and/or the separate devices may enable the user to obtain real-time graphical indications and textual profiles in a more socially acceptable manner (e.g., by periodically glancing down at the second device).

Turning now to FIG. 3, a method 44 of using display thresholds and recommendation rankings to present, profile information is shown. The method 44 may be implemented as a set of logic instructions stored in a machine- or computer-readable storage medium such as RAM, ROM, PROM, firmware, flash memory, etc., in configurable logic such as, for example, PLAs. FPGAs, CPLDs, in fixed-functionality hardware logic using circuit technology such as, for example, ASIC, CMOS or TTL technology, or any combination thereof For example, computer program code to carry out operations shown in method 30 may be written in any combination of one or more programming languages, including an object oriented programming language such as Java, Smalltalk C++ or the like and conventional procedural programming languages, such as the “C” programming language or similar programming languages.

Illustrated block 46 provides for scanning a scene in a video feed/signal, wherein a new face may be detected in the scene at block 48. A determination may be made at block 50 as to whether the face is recognized as a particular individual. If so, block 52 may determine whether the recognized individual is recommended to the user tor the presentation of detailed profile information (e.g., the recognized individual has an associated priority level). Thus, the recommendation determination at block 52 may take into consideration various factors such as shared interests, social networking connections, shared organizations, physical proximity, and so forth, as already discussed. If the recognized individual is recommended to the user, a determination may be made at block 54 as to whether a threshold related to a display constraint is exceeded. The threshold might be, for example, a maximum number of graphical indication boxes (e.g., four) that is based on screen size and/or resolution.

If the threshold is not exceeded, illustrated block 56 displays an appropriate graphical indication in the camera view and adds the textual profile to the sidebar. Otherwise, a determination may be made at block 58 as to whether the priority level (e.g., rank) of the newly recognized individual is higher than the priority level of any of the currently annotated individuals in the camera view. If so, the graphical indication and textual profile of the lowest ranked individual may be removed from the user interface at block 60 and illustrated block 56 displays the graphical indication and textual profile of the newly recognized individual. If no face is recognized at block 50, the newly recognized individual is not recommended to the user at block 52 or it is determined at block 58 that the newly recognized individual does not have a high enough rank, the illustrated process repeats the scene scan at block 46.

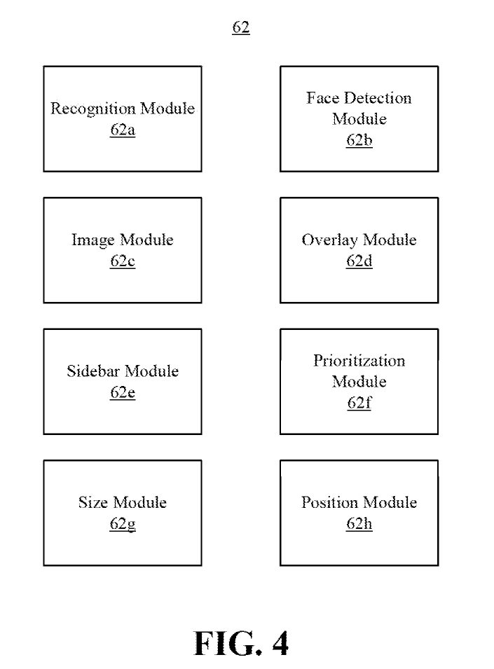

FIG. 4 shows a logic architecture 62 (62a-62h) that may present profile information. The illustrated architecture 62 may generally implement one or more aspects of the method 30 (FIG. 2) and/or the method 44 (FIG. 3), already discussed. More particularly, an image module 62c may receive image data and use a face detection module 62b to identify one or more faces in the image data. Additionally, the image module 62c may use a recognition module 62a to recognize the detected faces as belonging to particular individuals. In one example, the face detection module 62b and the recognition module 62a are implemented in an open source computer vision library such as, for example, OpenCV. The image module 62c may also generate a camera view based on the image data.

The illustrated architecture 62 also includes a prioritization module 62f to determine a first priority level for a first individual based on one or more of a shared interest between the first individual and a user, a social networking connection between the first individual and the user, a shared organization between the first individual and the user, a real-time physical proximity between the first individual and the user, etc., or any combination thereof. In addition, an overlay module 62d may overlay an area adjacent to a face of the first individual in the camera view with a first graphical indication of the basis for the first priority level associated with the first individual. In one example, the first graphical indication includes one or more icons. The overlay module 62d may also overlay an area adjacent to the face of the first individual in the camera view with a name of the first individual. The architecture 62 may also include a sidebar module 62e to display a sidebar adjacent to the camera view, wherein the sidebar includes a textual profile of the first individual.

As already noted, a relatively large number of faces may be recognized and annotated in the camera view using the techniques described herein. Thus, the prioritization module 62f may determine a second priority level for a second individual in the camera view, wherein the overlay module 62d may overlay an area adjacent to the face of the second individual with a second graphical indication of the basis for the second priority level. Additionally, the sidebar module 62e may incorporate a second textual profile of the second individual into the sidebar. In such a case, a position module 62h may determine a relative position of the first textual profile and the second textual profile based on the first priority level, the second priority level, and so forth. Similarly, a size module 62g may determine a relative size of the first graphical indication and the second graphical indication based on one or more display constraints, the first priority level, the second priority level, and so forth.

In one example, the image module 62c receives the image data from a camera of a mobile device, and outputs the camera view and the sidebar via a display of the same mobile device. Alternatively, the image module 62c might receive the image data from a camera of a first device, and output the camera view and the sidebar via a display of a second device.

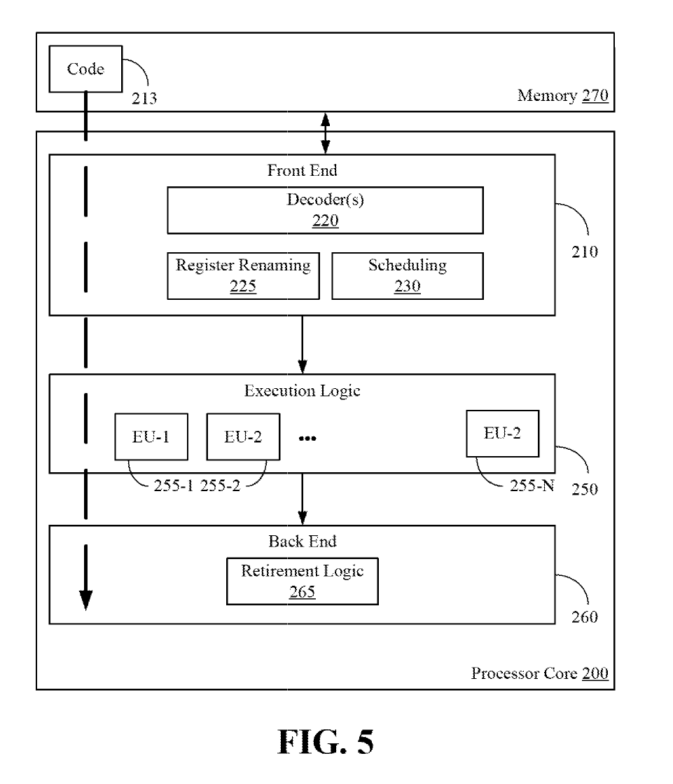

FIG. 5 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 5, a processing element may alternatively include more than one of the processor core 200 illustrated in FIG. 5. The processor core 200 may be a single-threaded core or, for at least one embodiment, the processor core 200 may be multithreaded in that it may include more than one hardware thread context or “logical processor”) per core.

FIG. 5 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the aforementioned logic architecture 62 (FIG. 4). The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 5, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

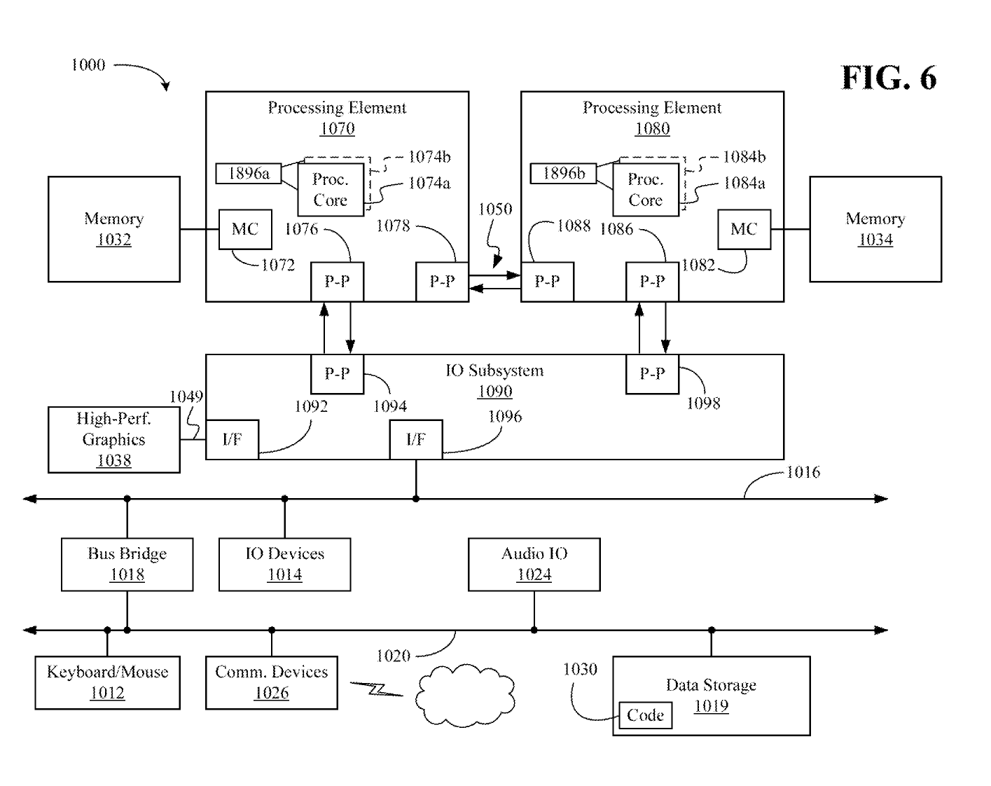

Referring now to FIG. 6, shown is a block diagram of a system 1000 embodiment in accordance with an embodiment. Shown in FIG. 6 is a Multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 6 may be implemented as a multi-drop bus rather than point-to-point interconnect.

As shown in FIG. 6, each of processing elements 1070 and 1080 may he multicore processors, including first and second processor cores (i.e., processor cores 1074a and 1074b and processor cores 1084a and 1084b). Such cores 1074, 1074b, 1084a, 1084b may be configured to execute instruction code in a manner similar to that discussed above in connection with FIG. 5.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b. respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may he present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 6, MC's 1072 and 1082 couple the processors to respective memories, namely a memory 1032 and a memory 1034, which may he portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086. respectively. As shown in FIG. 6, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 6, various I/O devices 1014 (e.g., cameras, displays) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement the aforementioned logic architecture 62 (FIG. 4), and may be similar to the code 213 (FIG. 5), already discussed. Further, an audio I/O 1024 may be coupled to second bus 1020.

Note that other embodiments are contemplated. For example, instead of the point-to-point architecture of FIG. 6, a system may implement a multi-drop bus or another such communication topology. Also, the elements of FIG. 6 may alternatively be partitioned using more or fewer integrated chips than shown in FIG. 6.

### Additional Notes and Examples

Example 1 may include an apparatus to present profile information, comprising an image module to generate a camera view based on image data, an overlay module to overlay an area adjacent to a face of a first individual in the camera view with a first graphical indication of a basis for a first priority level associated with the first individual, and a sidebar module to display a sidebar adjacent to the camera view, the sidebar including a first textual profile of the first individual.

Example 2 may include the apparatus of Example 1 wherein the first graphical indication is to include one or more icons.

Example 3 may include the apparatus of Example 1, wherein the overlay module is to overlay an area adjacent to the face of the first individual in the camera view with a name of the first individual.

Example 4 may include the apparatus of Example 1, wherein the overlay module is to overlay an area adjacent to a face of a second individual in the camera view with a second graphical indication of a basis for a second priority level associated with the second individual, and the sidebar module is to incorporate a second textual profile of the second individual into the sidebar.

Example 5 may include the apparatus of Example 4, further including a size module to determine a relative size of the first graphical indication and the second graphical indication based on one or more display constraints, the first priority level and the second priority level, and a position module to determine a relative position of the first textual profile and the second textual profile in the sidebar based on the first priority level and the second priority level.

Example 6 may include the apparatus of Example 1, wherein the image module is to receive the image data from a camera of a mobile device, and output the camera view and the sidebar via a display of the mobile device.

Example 7 may include the apparatus of Example 1, wherein the image module is to receive the image data from a camera of a first device, and output the camera view and the sidebar via a display of a second device.

Example 8 may include the apparatus of any one of Examples 1 to 7, further including a prioritization module to determine the first priority level based on one or more of a shared interest between the first individual and a user, a social networking connection between the first individual and the user, a shared organization between the first individual and the user or a real-time physical proximity between the first individual and the user.

Example 9 may include a method of presenting profile information, comprising generating a camera view based on image data, overlaying an area adjacent to a face of a first individual in the camera view with a first graphical indication of a basis for a first priority level associated with the first individual, and displaying a sidebar adjacent to the camera view, the sidebar including a first textual profile of the first individual.

Example 10 may include the method of Example 9, wherein the first graphical indication includes one or more icons.

Example 11 may include the method of Example 9, further including overlaying an area adjacent to the face of the first individual in the camera view with a name of the first individual.

Example 12 may include the method of Example 9, further including overlaying an area adjacent to a face of a second individual in the camera view with a second graphical indication of a basis for a second priority level associated with the second individual, and incorporating a second textual profile of the second individual into the sidebar.

Example 13 may include the method of Example 12, further including determining a relative size of the first graphical indication and the second graphical indication based on one or more display constraints, the first priority level and the second priority level, and determining a relative position of the first textual profile and the second textual profile in the sidebar based on the first priority level and the second priority level.

Example 14 may include the method of Example 9, further including receiving the image data from a camera of a mobile device, and outputting the camera view and the sidebar via a display of the mobile device.

Example 15 may include the method of Example 9, further including receiving the image data from a camera of a first device, and outputting the camera view and the sidebar via a display of a second device.

Example 16 may include the method of any one of Examples 9 to 15, further including determining the first priority level based on one or more of a shared interest between the first individual and a user, a social networking connection between the first individual and the user, a shared organization between the first individual and the user or a real-time physical proximity between the first individual and the user.

Example 17 may include at least one computer readable storage medium comprising a set of instructions which, if executed by a computing device, cause the computing device to generate a camera view based on image data, overlay an area adjacent to a face of a first individual in the camera view with a first graphical indication of a basis for a first priority level associated with the first individual, and display a sidebar adjacent to the camera view, the sidebar including a first textual profile of the first individual.

Example 18 may include the at least one computer readable storage medium of Example 17, wherein the first graphical indication is to include one or more icons.

Example 19 may include the at least one computer readable storage medium of Example 17, wherein the instructions, if executed, cause a computing device to overlay an area adjacent to the face of the first individual in the camera view with a name of the first individual.

Example 20 may include the at least one computer readable storage medium of Example 17 wherein the instructions, if executed, cause a computing device to overlay an area adjacent to a face of a second individual in the camera view with a second graphical indication of a basis for a second priority level associated with the second individual, and incorporate a second textual profile of the second individual into the sidebar.

Example 21 may include the at least one computer readable storage medium of Example 20, wherein the instructions, if executed, cause a computing device to determine a relative size of the first graphical indication and the second graphical indication based on one or more display constraints, the first priority level and the second priority level, and determine a relative position of the first textual profile and the second textual profile in the sidebar based on the first priority level and the second priority level.

Example 22 may include the at least one computer readable storage medium of Example 17, wherein the instructions, if executed, cause a computing device to receive the image data from a camera of a mobile device, and output the camera view and the sidebar via a display of the mobile device.

Example 23 may include the at least one computer readable storage medium of Example 17 wherein the instructions, if executed, cause a computing device to receive the image data from a camera of a first device, and output the camera view and the sidebar via a display of a second device.

Example 24 may include the at least one computer readable storage medium of any one of Examples 17 to 23, wherein the instructions, if executed, cause a computer to determine the first priority level based on one or more of a shared interest between the first individual and a user, a social networking connection between the first individual and the user, a shared organization between the first individual and the user or a real-time physical proximity between the first individual and the user.

Example 25 may include an apparatus to present profile information, comprising means for performing the method of any one of Examples 9 to 16.

Thus, techniques described herein may use icons to provide high level information in order to reduce the screen real estate occupied by graphical indication boxes. Additionally, determinations may be made as to who in the scene may be of most interest to the user and limit the profile information to those users. Moreover, varying amounts of profile information may be displayed depending upon proximity and/or relevance.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not he construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms“first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-24. (canceled)

25. An apparatus to present profile information, comprising:
an image module to generate a camera view based on image data;
an overlay module to overlay an area adjacent to a face of a first individual in the camera view with a first graphical indication of a basis for a first priority level associated with the first individual; and
a sidebar module to display a sidebar adjacent to the camera view, the sidebar including a first textual profile of the first individual.

26. The apparatus of claim 25, wherein the first graphical indication is to include one or more icons.

27. The apparatus of claim 25, wherein the overlay module is to overlay an area adjacent to the face of the first individual in the camera view with a name of the first individual.

28. The apparatus of claim 25, wherein the overlay module is to overlay an area adjacent to a face of a second individual in the camera view with a second graphical indication of a basis for a second priority level associated with the second individual, and the sidebar module is to incorporate a second textual profile of the second individual into the sidebar.

29. The apparatus of claim 28, further including:
a size module to determine a relative size of the first graphical indication and the second graphical indication based on one or more display constraints, the first priority level and the second priority level; and
a position module to determine a relative position of the first textual profile and the second textual profile in the sidebar based on the first priority level and the second priority level.

30. The apparatus of claim 25, wherein the image module is to receive the image data from a camera of a mobile device, and output the camera view and the sidebar via a display of the mobile device.

31. The apparatus of claim 25, wherein the image module is to receive the image data from a camera of a first device, and output the camera view and the sidebar via a display of a second device.

32. The apparatus of claim 25, further including a prioritization module to determine the first priority level based on one or more of a shared interest between the first individual and a user, a social networking connection between the first individual and the user, a shared organization between the first individual and the user or a real-time physical proximity between the first individual and the user.

33. A method of presenting profile information, comprising:
generating a camera view based on image data;
overlaying an area adjacent to a face of a first individual in the camera view with a first graphical indication of a basis for a first priority level associated with the first individual; and
displaying a sidebar adjacent to the camera view, the sidebar including a first textual profile of the first individual.

34. The method of claim 33, wherein the first graphical indication includes one or more icons.

35. The method of claim 33, further including overlaying an area adjacent to the face of the first individual in the camera view with a name of the first individual.

36. The method of claim 33, further including:
overlaying an area adjacent to a face of a second individual in the camera view with a second graphical indication of a basis for a second priority level associated with the second individual; and
incorporating a second textual profile of the second individual into the sidebar.

37. The method of claim 36, further including:
determining a relative size of the first graphical indication and the second graphical indication based on one or more display constraints, the first priority level and the second priority level; and
determining a relative position of the first textual profile and the second textual profile in the sidebar based on the first priority level and the second priority level.

38. The method of claim 33, further including:
receiving the image data from a camera of a mobile device; and
outputting the camera view and the sidebar via a display of the mobile device.

39. The method of claim 33, further including:
receiving the image data from a camera of a first device; and
outputting the camera view and the sidebar via a display of a second device.

40. The method of claim 33, further including determining the first priority level based on one or more of a shared interest between the first individual and a user, a social networking connection between the first individual and the user, a shared organization between the first individual and the user or a real-time physical proximity between the first individual and the user.

41. At least one computer readable storage medium comprising a set of instructions which, if executed by a computing device, cause the computing device to:
generate a camera view based on image data;
overlay an area adjacent to a face of a first individual in the camera view with a first graphical indication of a basis for a first priority level associated with the first individual; and
display a sidebar adjacent to the camera view, the sidebar including a first textual profile of the first individual.

42. The at least one computer readable storage medium of claim 41, wherein the first graphical indication is to include one or more icons.

43. The at least one computer readable storage medium of claim 41, wherein the instructions, if executed, cause a computing device to overlay an area adjacent to the face of the first individual in the camera view with a name of the first individual.

44. The at least one computer readable storage medium of claim 41, wherein the instructions, if executed, cause a computing device to:
overlay an area adjacent to a face of a second individual in the camera view with a second graphical indication of a basis for a second priority level associated with the second individual; and
incorporate a second textual profile of the second individual into the sidebar.

45. The at least one computer readable storage medium of claim 44, wherein the instructions, if executed, cause a computing device to:
determine a relative size of the first graphical indication and the second graphical indication based on one or more display constraints, the first priority level and the second priority level; and
determine a relative position of the first textual profile and the second textual profile in the sidebar based on the first priority level and the second priority level.

46. The at least one computer readable storage medium of claim 41, wherein the instructions, if executed, cause a computing device to:
receive the image data from a camera of a mobile device; and
output the camera view and the sidebar via a display of the mobile device.

47. The at least one computer readable storage medium of claim 41, wherein the instructions, if executed, cause a computing device to:
receive the image data from a camera of a first device; and
output the camera view and the sidebar via a display of a second device.

48. The at least one computer readable storage medium of claim 41, wherein the instructions, if executed, cause a computer to determine the first priority level based on one or more of a shared interest between the first individual and a user, a social networking connection between the first individual and the user, a shared organization between the first individual and the user or a real-time physical proximity between the first individual and the user.
